(19) United States
(12) Patent Application Publication
(10) Pub. No.: US 2015/0330304 A1
(43) Pub. Date: Nov. 19, 2015

(54) ENGINE WITH THRUST VECTOR CONTROL

(71) Applicant: Viktor LYATKHER, (US)

(72) Inventor: Viktor LYATKHER, Richmond Hts, OH (US)

(21) Appl. No.: 14/623,014

(22) Filed: Feb. 16, 2015

(30) Foreign Application Priority Data
May 13, 2014 (RU) 2014119114/06

(51) Int. Cl. F02C 5/04

(52) U.S. Cl. CPC F02C 5/04

(57) ABSTRACT

The invention can be used to move any objects at any directions. The engine comprises the orthogonal turbines with jet propulsion control flow blades. To do this in the body of the blade is made of the cavity and along the surface of the blades is made stream result weekend of the slotted holes. The blades through the hollow arm is connected with the hollow shaft. Inside the shaft coaxially aligned him with the formation of the annular gap has a hollow distributor pipe with holes in the wall through which the cavity distribution pipeline communicates with the cavities traverse in moments of coincidence of the axes of the holes and traverse. The distribution pipeline is connected to a source of fuel-air mixture under pressure. In each cavity of the blade set of spark plugs connected to the induction coil.

### CROSS-REFERENCE TO RELATED APPLICATIONS

This patent claims priority to Russian patent application Serial No. 2014119114/06 (030106) filed on May 13, 2014, currently issued as a patent. Decision on grant of Russian patent is issued on Jan. 13, 2015.

### FIELD OF THE INVENTION

The invention relates to energy and transport, in particular to the universal power engine with thrust vector control, which can be used to move different, almost any object that you want to move from one place to another, for example, this power engine can find application in the transport machines both the land ones and air or above-water ones.

### BACKGROUND

There is known an engine of a air-cushion vehicle which comprises a load-bearing structure with a platform, a flexible side fence, a source of pressure in the fenced zone and a wheeled mover (see the patent GB N⁰ 1465382, cl. B60V 1/00, Feb. 23, 1977).

In this vehicle the source of high pressure is removed from the supporting surface. therefore, the formation of an air cushion is due to the static pressure increase in the area of the fence between the base of the vehicle and the supporting surface without the use of effect velocity head, which reduces the lifting force generated by an air cushion and requires increased airflow, sharply limiting the ability to use this power engine application such as vehicle in this case.

The engine equipped with the orthogonal turbines units with jet control of the media flow on the blades is the most similar to the invention from the view of the technical essence and the results achieved. Two cavities are in these blades to supply the media to control jet generated throw outlet slots located along the blades. Blades of the turbines have the aerofoil profile. Two cavities with outlet slots are formed inside the partition which divides the internal space of the blades. The outlet slots are directed to the corresponding surface of the blade behind the point of its profile maximum thickness.

The blades are installed on hollow shaft mounted for rotation using hollow cross arms with streamlined profile. These cross arms are perpendicular to the shaft and the cavities of the blades, of the crossed arms and of the shaft are interconnected. There is a stationary hollow gas-distribution pipeline with holes in its walls, used to ensure the connection between the gas-distribution pipeline cavity and the cross arm cavities, inside the hollow shaft (coaxial to it with annular gap). Herewith the distribution pipeline is connected to a source of continuous or pulse supply of gaseous media under pressure (see patent RU No. 2327059, CL F03G7/08, 20.062.008).

This engine allows to create a device that can move on the ground and in the air due to the interaction of the rotating blades of the rotors with the environment. However, the efficiency of this engine is relatively small due to its energy loss.

### SUMMARY

The object of this invention is to increase the interaction efficiency of the rotating rotors' blades of the engine.

This problem is solved and the technical result is achieved due to the fact that the engine with thrust vector control is equipped with at least one blade orthogonal turbine with jet circulation control flow of the blades; these blades have at least one cavity to supply the control media to jet generation outlet slots located along the blade; two cavities with outlet slots are formed inside the partition which divides the internal space of the blades; the blades of each turbine have the aerofoil profile; each output slot is displayed on the corresponding surface of the blade in the area behind the point the maximum thickness of the profile of the blade; the blades are installed on hollow shaft mounted for rotation using hollow cross anus made from streamlined profile; these cross arms are perpendicular to the shaft and the cavities of the blades of the crossed arms and of the shaft are interconnected; there is a stationary hollow gas-distribution pipeline with holes in its walls, used to ensure the connection between the gas-distribution pipeline cavity and the cross arm cavities, inside the hollow shaft (coaxial to it with annular gap); distribution pipeline is connected to a source of continuous or pulse supply of gaseous medium under pressure; each cavity of each blade is equipped with spark plugs burning, the fuel-air mixture connected to the induction coils of the ignition system.

The blades may be straight.

The blades can be made along a helical line.

The blades can be set multilevel.

The increasing the efficiency of the engine is due to the combination described above. A spark ignition of an air-fuel mixture in each cavity of each blade is installed, and spark plugs are connected to the induction coil of the ignition system and gas distribution pipe connected to the supply system of fuel-air mixture.

### BRIEF DESCRIPTION OF DRAWINGS

In FIG. 1 shows a longitudinal section of one blade orthogonal turbine with jet circulation control flow of the blades.

FIG. 2 presents the cross-section a-a in FIG. 1 with nozzle orifices for creating the jet relative to the shaft along the outer surface of each blade.

FIG. 3 presents the cross-section a-a in FIG. 1 with nozzle orifices for a jet generation along each blade surface.

FIG. 4 shows a cross-section of the blade.

FIG. 5 presents the photo—General view of the curvilinear orthogonal blades of the turbine.

FIG. 6 presents the layout of the blades in two rows with straight axes of the blades.

FIG. 7 presents the photo of model of unit with two blades with controlled jets.

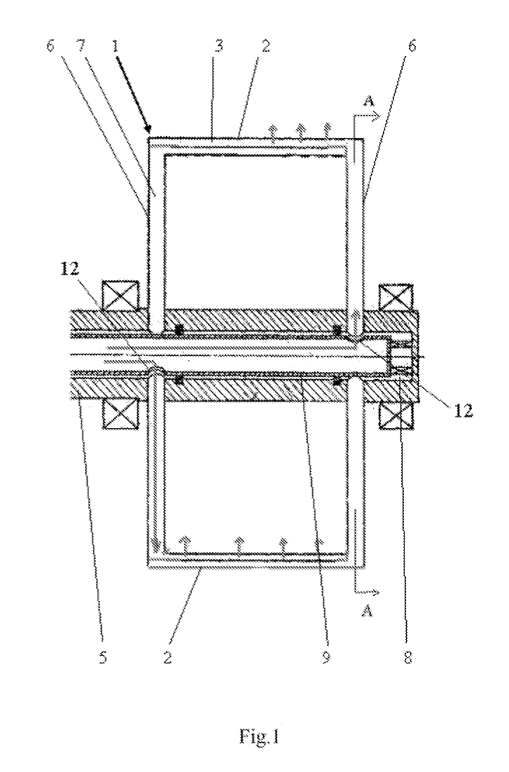

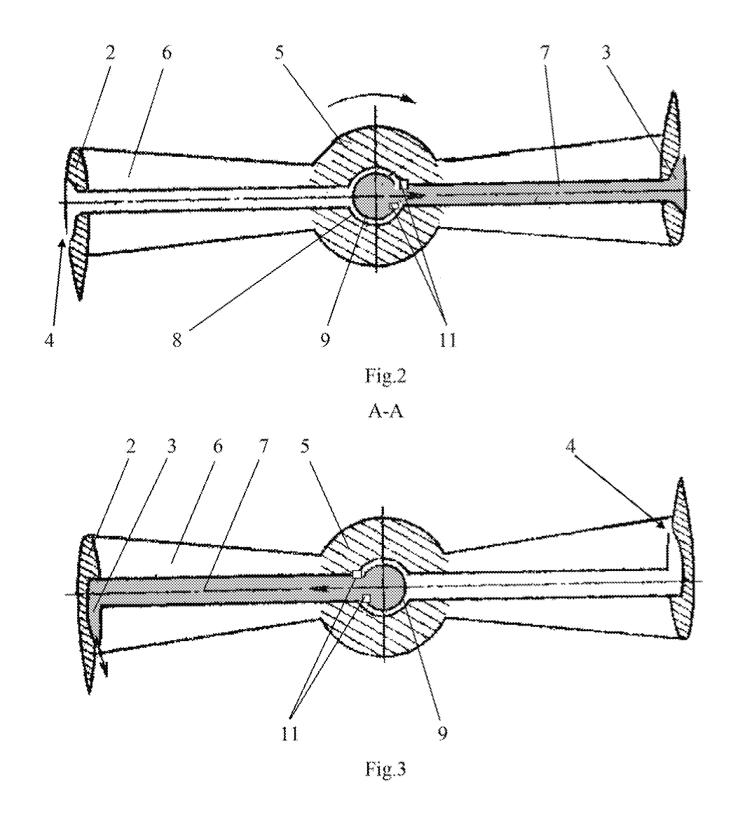

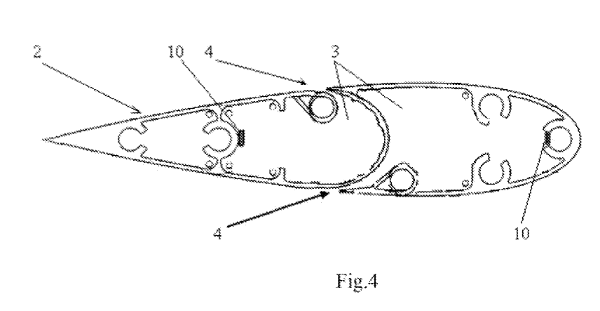

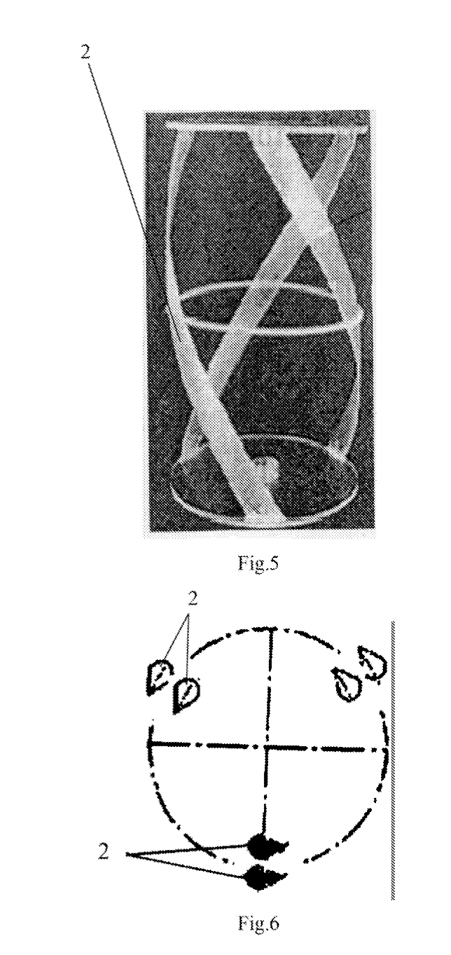

### DETAILED DESCRIPTION OF THE PREFERRED EMBODIMENT

The engine with controlled thrust vector contains at least one orthogonal turbine 1 with jet circulation control of the blades 2. For this purpose these blades have at least one cavity 3 to supply the control media to jet generation outlet slots 4 located along the blades.

The blades 2 each turbine 1 have the aerofoil profile. Each output slot 4 is directed to the corresponding surface of the blade 2 behind, the point of its profile maximum thickness. The blades 2 are installed on a hollow shaft 5 mounted for rotation using hollow cross arms 6 made from streamlined profile. These cross arms are perpendicular to the shaft 5 and the cavities 3, 7, and 8 of the blades 2, of the crossed arms 6 and of the shaft 5 respectively are interconnected. Inside the hollow shaft 5 (coaxial to it with annular gap) there is a stationary hollow gas-distribution pipeline 9 with holes 12 in its walls used to ensure the connection between the gas-distribution pipeline 9 cavity and the cross arm 6 cavities 7.

Distribution pipe 9 is connected to a source of continuous or pulsed supply of gaseous medium under pressure (not shown in the drawings), each cavity 3 of each blade 2 is installed spark plugs 10 air-fuel mixture that is connected to the induction coil 11 system ignition and distribution pipe 9 is connected to the supply system of fuel-air mixture.

The blades 2 may be straight, helical and may be set multilevel.

To put in motion a vehicle equipped with the described engine fuel-air mixture is supplied to the cavity 3 of the blades 2 of the orthogonal turbine 1 through distribution pipeline 9 and further through the shaft 5 and crossed arms 6. This fuel-air mixture is burnt up in the cavity (or cavities) 3 of the blades 2 with spark plugs 10. As a result of the fuel-air mixture burning combustion products are generated; these products exit through the jet generation outlet slots 4 and form a jet stream rotating the blades 2 of the orthogonal turbine 1 and creating lifting force perpendicular to the axis of the turbine. The spatial orientation of this force is determined by the position of the holes 12 in the distribution pipeline 9.

The lifting force magnitude is regulated by the shaft 5 speed and consumption of the fuel-air mixture supplied to the blades 2. The direction of the force acting on the engine is determined by the position of the holes 12 in the distribution pipeline 9.

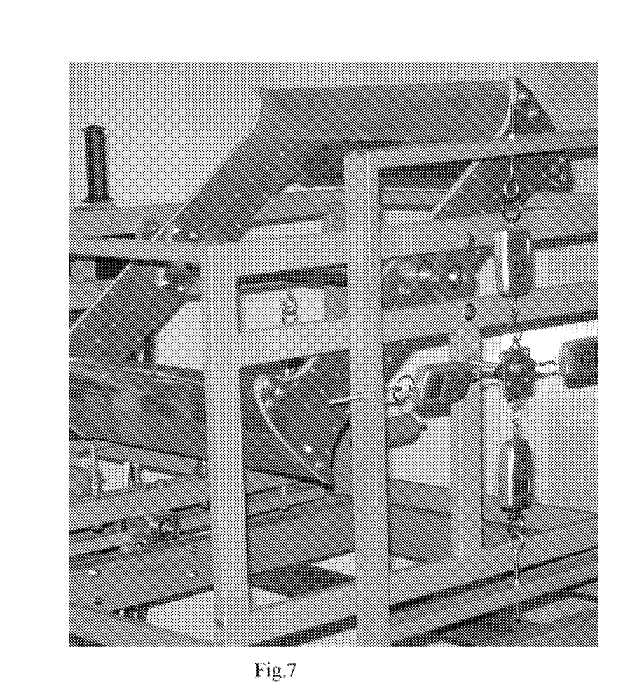

The present invention can be used in automotive, construction, oil and gas and other industries that need to be transported to lift or move a variety of goods. The test of model (FIG. 7) confirmed efficiency of unit.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

1. A power engine with controlled thrust vector comprising:
at least one turbine placed orthogonal to a flow; the turbine having jet-circulation control of the flow of a gaseous medium around blades,
the blades are made with at least one cavity for supplying the medium flow into slotted holes, the blades are airfoil ones,
each output of each slotted hole is on a surface of the blade in an area behind a point of maximum thickness of a profile of the blade;
the blades are is installed on a hollow shaft the shaft being able to rotate: the blades are positioned on the shall through hollow traverses with streamlined profiles, perpendicular to the shaft, and
the hollow spaces of the blades, the traverses and the shaft are connected among themselves;
and a fixed hollow distribution pipeline is coaxially placed within the hollow shaft with an annular gap between the shaft and the pipeline;
the pipeline is made in as wall with holes through which a hollow space of the distribution pipe is connected with the hollow space of the traverses, and
the pipeline is connected to a source of continuous or pulsed supply of the gaseous medium under pressure;
wherein spark plugs air-fuel mixture are installed in each hollow space of each blade the spark plugs are connected to an induction coil ignition system, and the pipeline is connected to a supply system of fuel-air mixture.

2. The power engine according to claim 1, wherein the blades are made straight.

3. The power engine according to claim 1, wherein the blades are made along a helical line.

4. The power engine according to claim 1, wherein the blades are fitted tiered.
